(19) United States
(12) Patent Application Publication
(10) Pub. No.: US 2021/0327252 A1
(43) Pub. Date: Oct. 21, 2021

(54) Safe Space with Wipe Away

(71) Applicant: The Indoor Lab, LLC, Dana Point, CA (US)

(72) Inventors: Patrick Joseph Mooney, Yorba Linda, CA (US); Patrick David Blattner, Dana Point, CA (US)

(73) Assignee: The Indoor Lab, LLC, Dana Point, CA (US)

(21) Appl. No.: 17/231,791

(22) Filed: Apr. 15, 2021

Related U.S. Application Data
(60) Provisional application No. 63/010,989, filed on Apr. 16, 2020.

(51) Int. Cl. G08B 21/24

(52) U.S. Cl. CPC G08B 21/245

(57) ABSTRACT

A system for tracking people moving through a predefined area using an electronic tracking device for real-time tracking of people as they move through a predefined area.

### CROSS-REFERENCE TO RELATED APPLICATIONS

This application claims priority to provisional application no. U.S. 63/010989, filed Apr. 16, 2020, the entire contents of which are hereby incorporated by reference.

### STATEMENT REGARDING FEDERALLY SPONSORED RESEARCH

Not Applicable

### FIELD OF THE INVENTION

This application relates to using sensors to monitor foot traffic and especially for tracking foot traffic relative to employees or staff.

### BACKGROUND OF THE INVENTION

COVID-19 has given rise to the need to track safe distances between customers, as well as tracking the locations of customers and ensuring that the business has properly cleaned the areas were customers were present.

What is needed is technology which enables businesses to track customers locations in real-time, relative to each other and also relative to employees. It would also be desirable track customers and employees without capturing any Personally Identifiable Information (PII).

### BRIEF SUMMARY OF THE INVENTION

Using sensors to track foot traffic has many applications and applicant's believe they are the first to use LIDAR technology to track foot traffic. The inventive sensor system allows for tracking customers in an area, determining where the customers go, for cleaning purposes, as well as keeping track of which staff interactions with customers, which aisles and bays received the most customer attention and operational uses such as counting customers in a business, counting customers entering through a door, determining customer direction, tracking staff or employee interactions with customers, and security purposes as well.

The inventive system provides for tracking people moving through a predefined area, by using an electronic tracking device for real-time tracking of people as they move through a predefined area. In one embodiment of the invention, one or more LIDAR devices is used to track customers in an area.

The employees or staff operating in the predefined area wear a reflective badge to allow the system to differentiate between employees or staff and other people in the predefined area. This allows the system to track staff locations in the area, track staff engagement with customers, plot engagements, track staff intercepts of customers, optimize the number and location of staff in an area and perform gap analysis.

The system can also be used for security, such as by maintaining exclusion zones and tracking customer violations of the exclusion zones. The system can provide security alerts, detect bag leave behind situations, detect speeding and locate the closest staff person to a detected perpetrator.

The system can also be used for operational purposes, such as for facility counts, door counts, providing usage statistics, provide load balancing, provide customer direction and provide custodial locations.

The system can include software for providing an indication of which parts of the predefined area need to be cleaned by tracking which parts of the predefined area where occupied by the people, and then tracking staff to ensure that all the used portions of the area are visited by the staff for cleaning. The system can provide cleaning alerts based on threshold levels of customer utilization of an area, and when an area exceeds a predetermined maximum recommended usage. The system can include software for the ability to measure what has been cleaned, what has not been cleaned, and when. The system can further include software for the ability to score/rate cleanliness and adherence of social distancing of a place of business.

The software can also provide the ability to schedule cleaning based on historical pathing and saturation trends or for interfacing with automated cleaning devices to schedule cleaning of an area.

The system can be used for tracking customers pausing at locations, for example at particular aisle and bay numbers, or for the ability to replay and re-analyze historical data, or measure density/saturation and frequency of traffic, or for the tracking of paths, pathing and common paths or providing the ability to track frequency of saturation of an area. The software can provide the ability to track frequency of saturation of an area.

The system can further including software for the ability to publish data for private/public consumption via an API (application program interface).

The system can further including software for alerting the closest staff person to a detected perpetrator or for detecting a left behind bag.

### BRIEF DESCRIPTION OF THE DRAWINGS

FIG. 1 is a schematic view showing example coverage area of the inventive system.

FIG. 2 is a view showing the live foot traffic, traffic trail and traffic paths.

FIG. 3 is a view showing Wipe Away™ to ensure an area has been properly cleaned.

FIG. 4 is a more detailed view showing Wipe Away™ to ensure an area has been properly cleaned.

FIG. 5 shows analytics capabilities to provide detailed traffic mapping and saturation information to inform management of areas that need cleaning, based on saturation KPI's.

FIG. 6 shows a comparison of LiDAR versus other sensor technology.

FIG. 7 shows in aisle/bay conversion information.

FIG. 8 shows how reflective badges are used by the system to track associate engagement with customers and to create engagement metrics and deficiency reporting.

FIG. 9 is chart showing footprint measurement.

FIG. 10 shows flow information for a restaurant, which can be viewed real-time on a mobile smartphone.

FIG. 11 shows flow information for a bank.

FIG. 12 shows collision detection, pathing and replay information.

FIG. 13 shows the various types of reflective badges which can be used with the system.

FIG. 14 shows a picture of an engagement as well as the raw data stream showing the same engagement.

FIG. 15 shows a different view of an associate customer engagement.

FIG. 16 shows some optimization analytics information comparing stores.

FIG. 17 shows a graph of hour by hour engagement information and deficiency information.

FIG. 18 shows an entire day worth of engagement information.

FIG. 19 shows a day worth of engagement ratio data.

FIG. 20 shows zone engagement information for a particular store.

FIG. 21 shows in-bay conversion data for a box store.

FIG. 22 shows the zone definitions for determining in-bay conversion data.

FIG. 23 shows a schematic related to perpetrator tracking showing either zone detection or a perpetrator exceeding a speed limit and being tracked by a staff person.

FIG. 24 shows another schematic related to perpetrator tracking showing a security guard running after a perpetrator.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

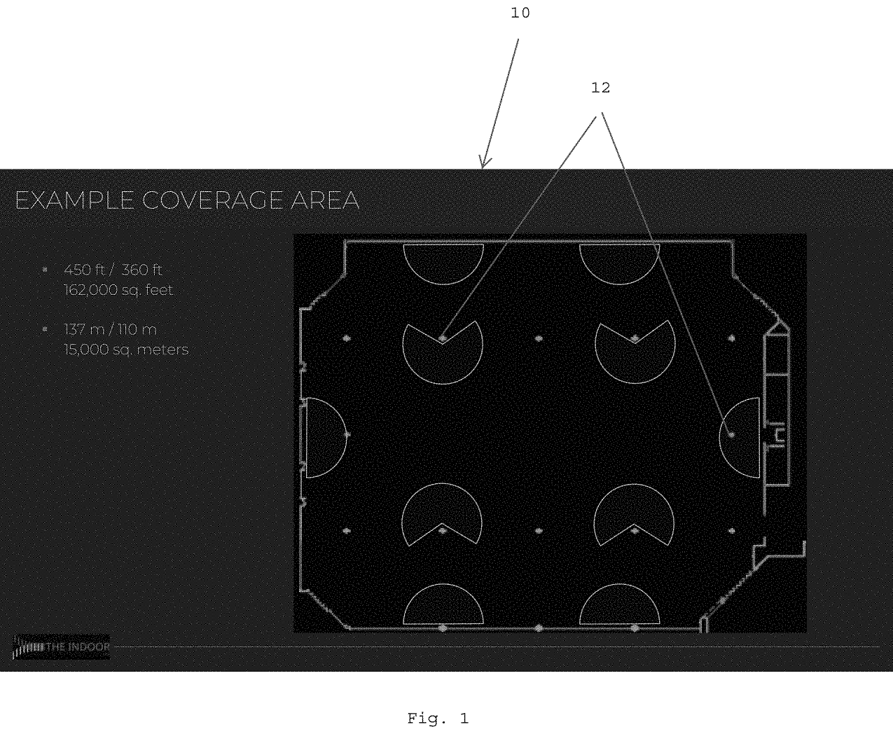

Applicant's are the first to bring LiDAR out of the autonomous driving vehicle and track customers with precision accuracy. One example LiDAR device which can be utilized is the Cepton P90 sensor. For example, multiple P90 LiDAR devices can be arranged in a predefined area, which can be an event center, a place of business or even an outdoor area. The predefind area is shown at 10 in FIG. 1 and the LiDAR devices are shown at 12. LiDAR stands for Light Detection & Ranging and each sensor provides:

24 Non-visible beams emitting from sensor

No ceiling height restrictions

No lighting restrictions

Horizontal field of view

10 Positions Per Second

200+ Foot Detection

3 cm Accuracy

90-Degree field of view

Line of sight detection.

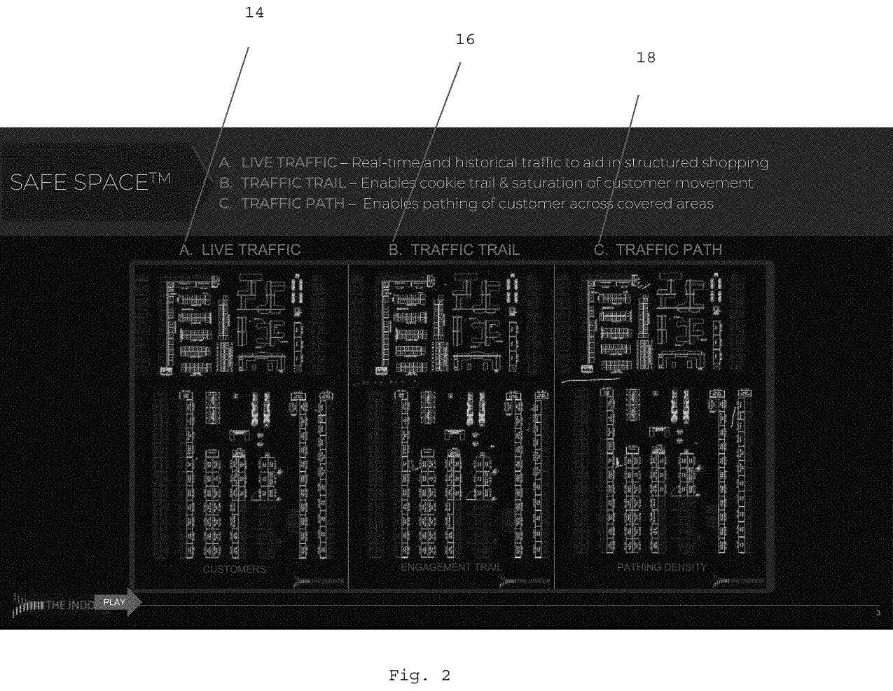

The LiDAR sensors 12 allow the system to perform live real-time tracking of foot traffic in an area, which can provide live traffic and historical traffic monitoring, such as shown at 14 in FIG. 2. This technology can measure a customer's vapor trail from the moment they step into a location, essentially creating black light tracking and tracing detection that helps identify foot traffic and areas that need to be sanitized, which is especially useful during a pandemic such as COVID-19. The technology supports anonymous contact tracing efforts that have been put in place by many state and local governments throughout the phased reopening plans.

A Safe Place™ system allows that locations have been cleaned, distancing measures are followed and occupancy levels are maintained. Three indexes are utilized for scoring a facility which will help businesses market to their customers on the high standards employed by being Safe Place™ enabled. The inventive system is also the first to create a cleaning detection product in combination with Wipe Away™ technology and 3D LiDAR to detect when locations or areas have been vacated and then sanitized. The inventive system is modeled after the FDA restaurant cleaning and grading standards.

The software algorithms are tuned to the unique advantages that LiDAR provides in order to see people, objects, and structures within a place of business. Coupled with easy reporting tools, the inventive system is able to give a clear view to businesses of their space and show consumers they are entering a clean, safe environment. It will help support the reopening plans and, equally as important, how to stay open for many businesses that want to provide a safe and healthy environment for their workers and consumers to help meet the rules and regulations that are in place for social distancing. It also allows events, restaurants and other organizations to assess how they clean and sanitize; the number of people allowed in the business; the flow of foot traffic and more.

The system can provide a traffic trail, as shown at 16 in FIG. 2, which allows cookie trail and saturation of customer movement. The system can provide pathing of customer across covered areas, as shown at 18.

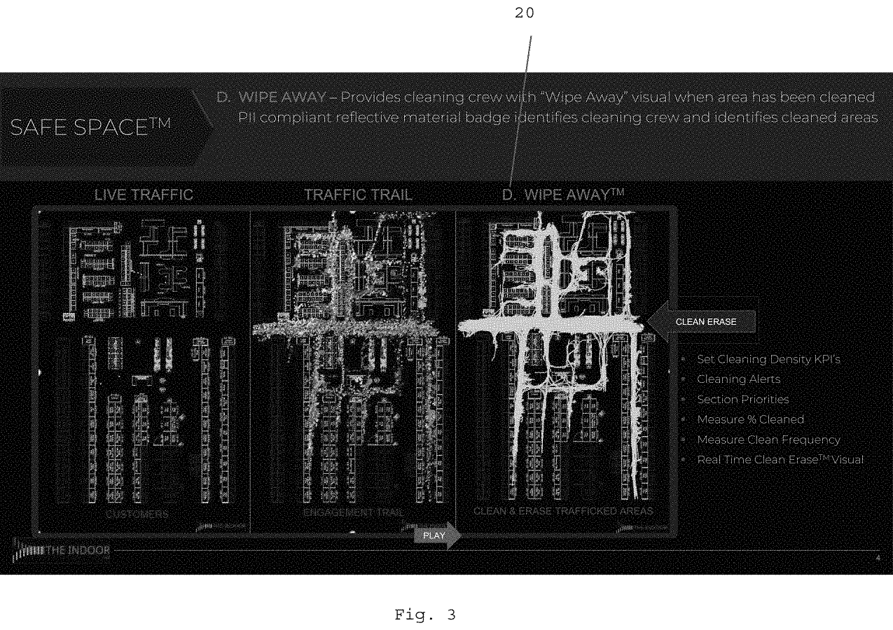

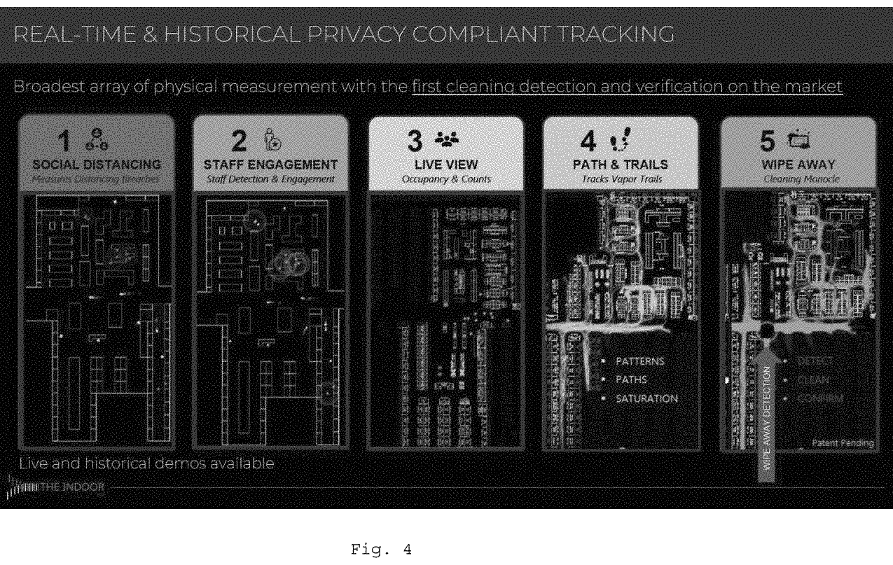

Referring to FIGS. 3 and 4, it can be seen that by having the cleaning employees or staff wear a reflective badge, the system can provide a visual indication of when an area has been cleaned (see the yellow at 20), which is called WipeAway™. There are two methods for WipeAway™: geometric positioning with x, y, z coordinates and zone positioning with zone locations. Geometric positioning detects a known custodial person at the exact location after the location has been occupied by another person, and software methods are used to track the sanitization of that area.

Zone positioning with zone locations is used to detect a known custodial person within the zone of the location that has been occupied and then vacated by another person, and software methods are track the sanitization of the zone. Multiple types of badges could be provided, for example with a striped pattern, to differentiate between multiple categories of persons. For example, it might be desirable to differentiate between employees, a second category of person wearing a different type of badge, such as a VIP guest, and everybody else (i.e. those not wearing any type of badge).

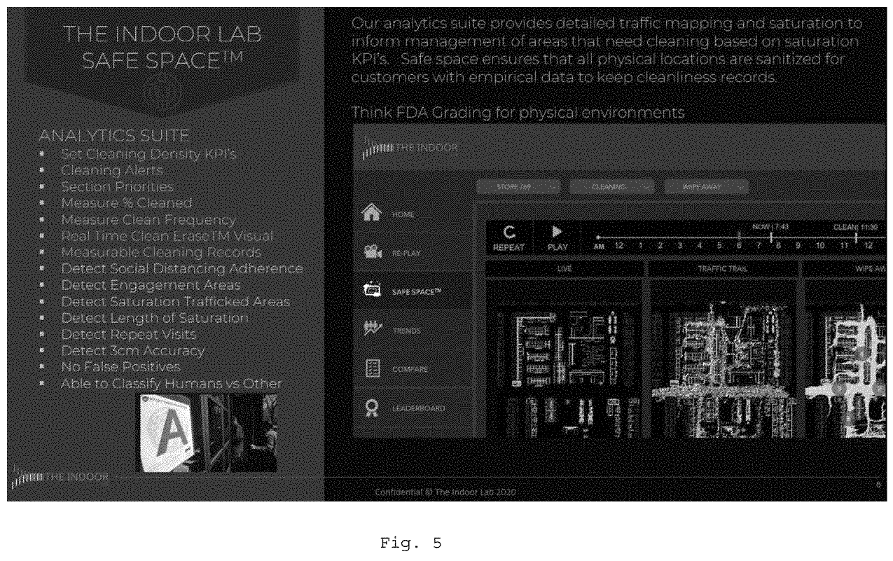

FIG. 5 shows more information about Safe Place™.

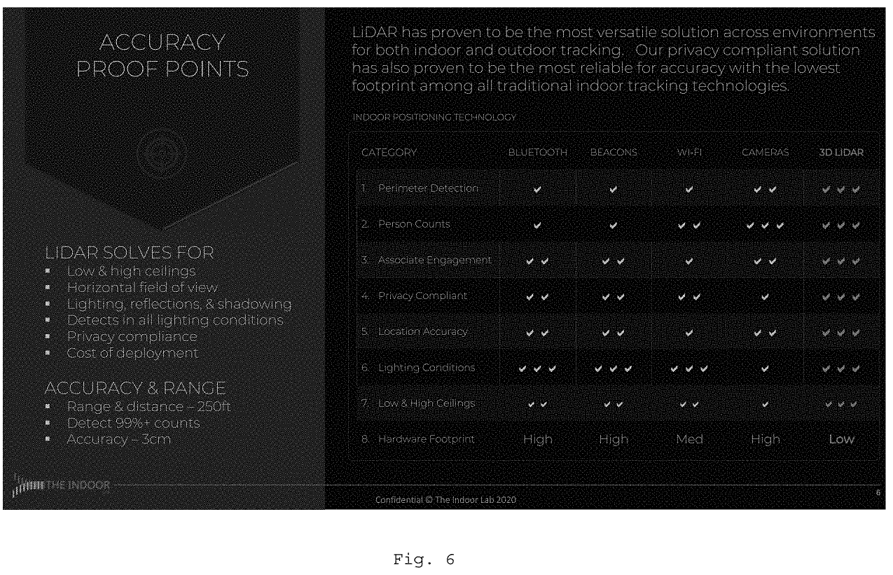

FIG. 6 shows a comparison of sensor technology and shows why 3D LiDAR is preferred as a sensor.

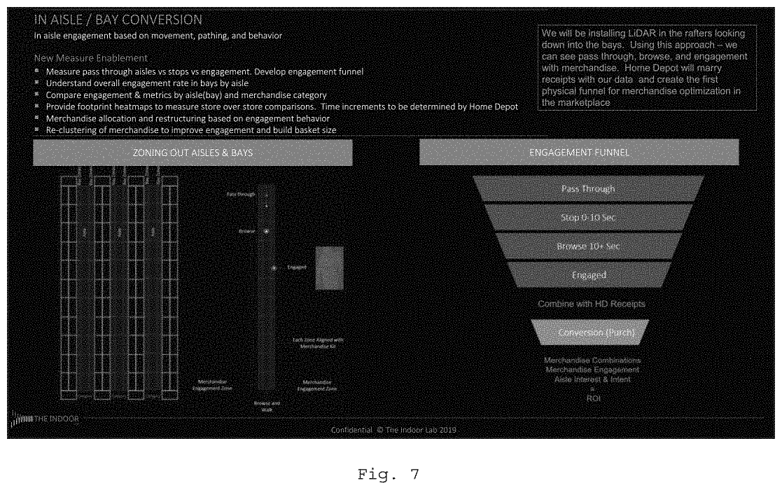

FIG. 7 shows how LiDAR can be used from the rafters in a box store, which has aisles and bays so measure pass through aisles versus stops versus engagements.

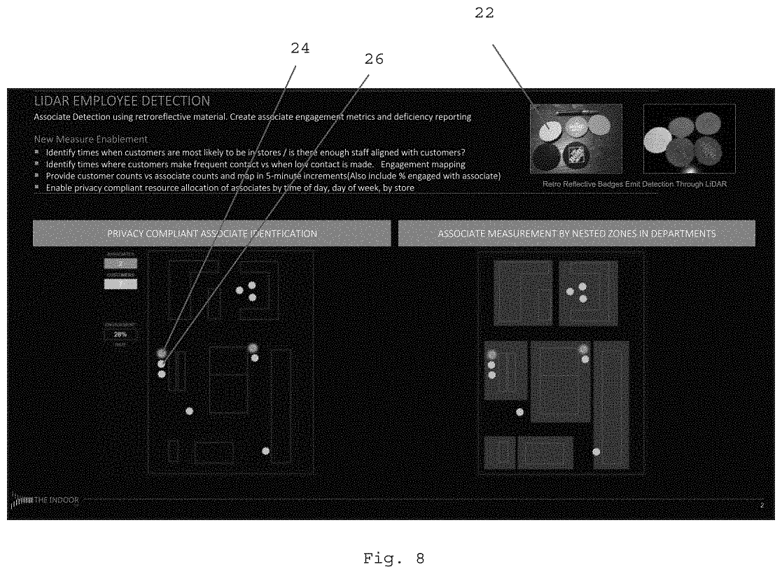

FIG. 8 shows reflective badges 22 worn by the employees. The staff are shown in Orange at 24, while the customers are shown at 26 in white. The software can provide engagement metrics which allow identification of times when customers are most likely to be in stores and identify if enough employees are on duty, as well as identify times of frequent contact with employees versus low contact times.

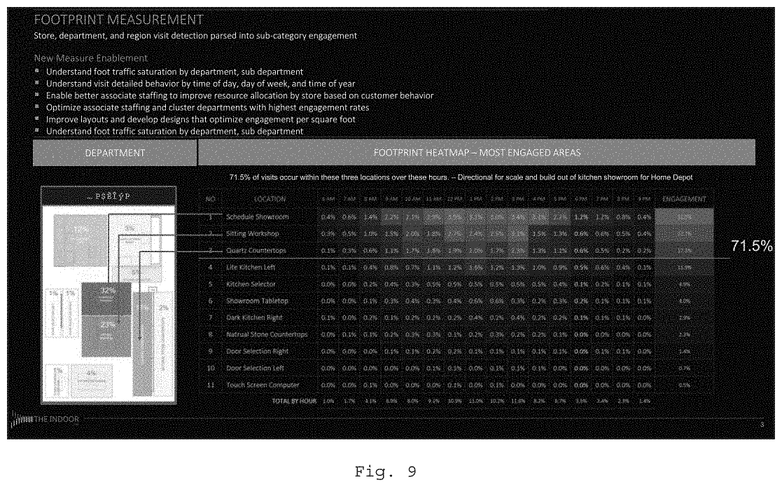

FIG. 9 shows a footprint heatmap measured by time of day and location.

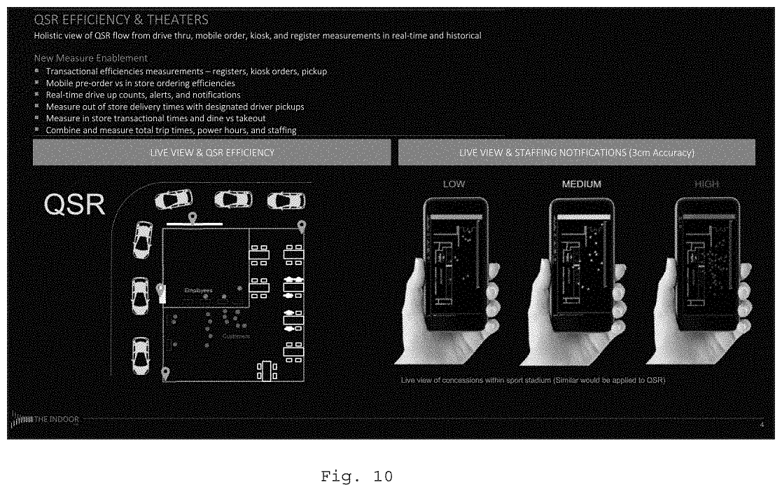

FIG. 10 shows a quick service restaurant (QSR) efficiency and flow for a drive thru restaurant, with staff shown in green and customers in red.

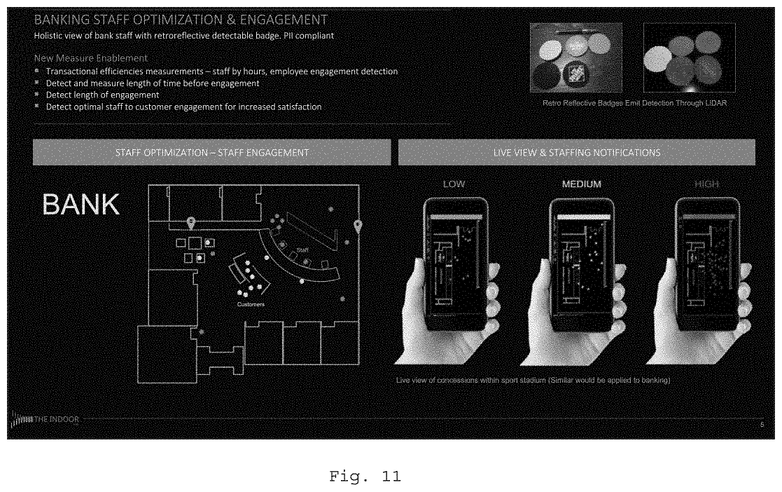

FIG. 11 shows efficiency and flow for a bank, with staff shown in green and customers shown in yellow.

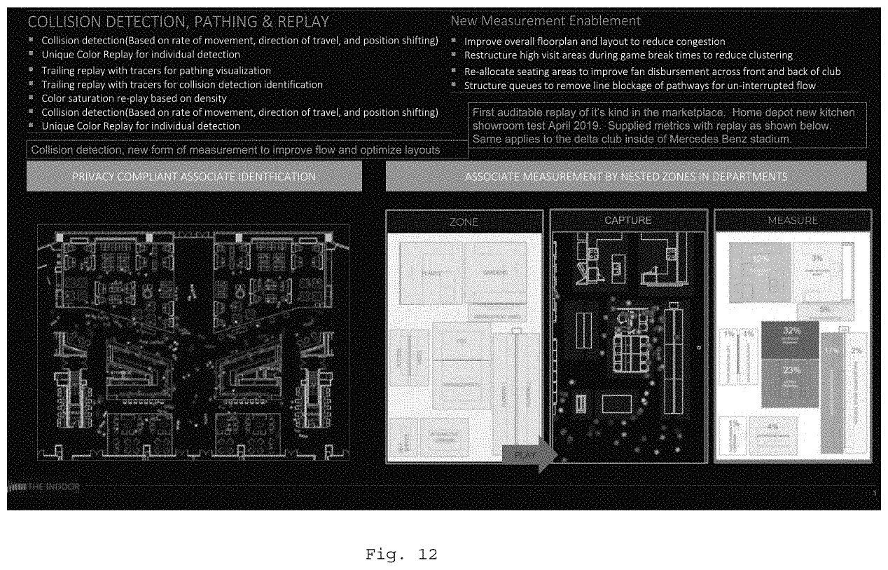

FIG. 12 shows a diagram used for collision detection, pathing used for improving flow and optimizing layouts.

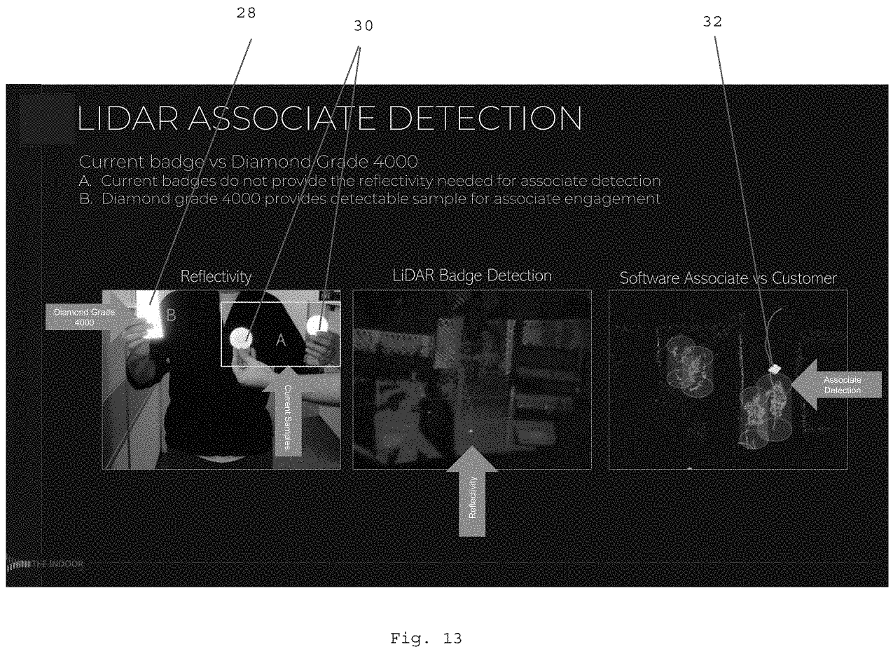

FIG. 13 shows various levels of reflective badges which can be used, as preferred. The Diamond Grade 4000 is the most reflective compared to current badges shown at 30. The software shows the staff person wearing the badge 28 at 32, engaged with a customer (no badge). The system also supports Garrison IR patches, with the IR being non-detectable to the human eye.

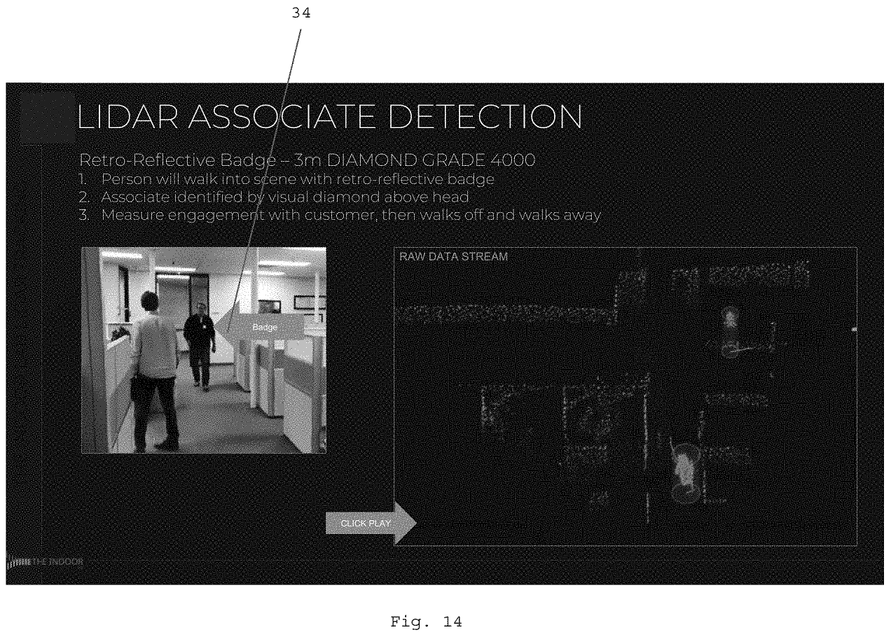

FIG. 14 shows a person entering an area with a badge (shown at 34). As in FIG. 13, the software shows the staff person with a visual diamond above their head.

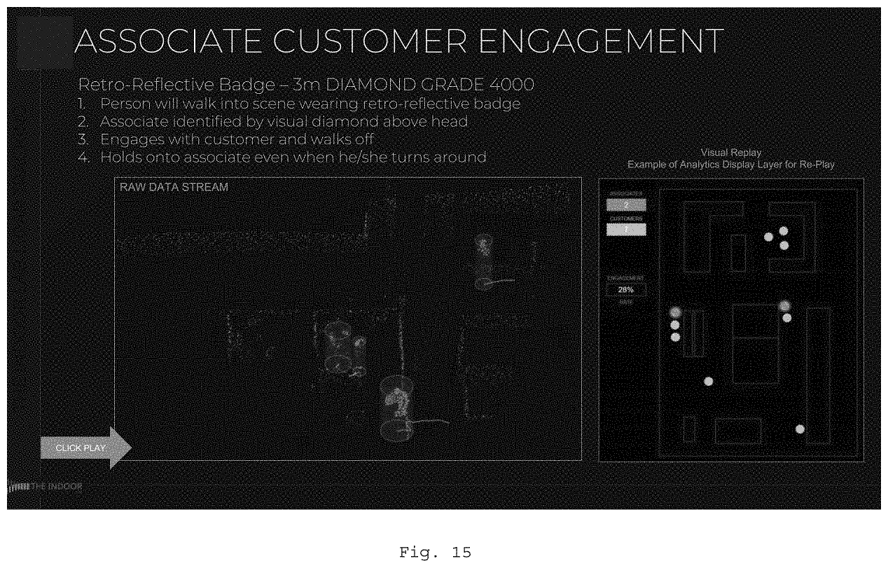

FIG. 15 is another figure showing staff/customer engagement. The staff are shown in Orange and the customers in white.

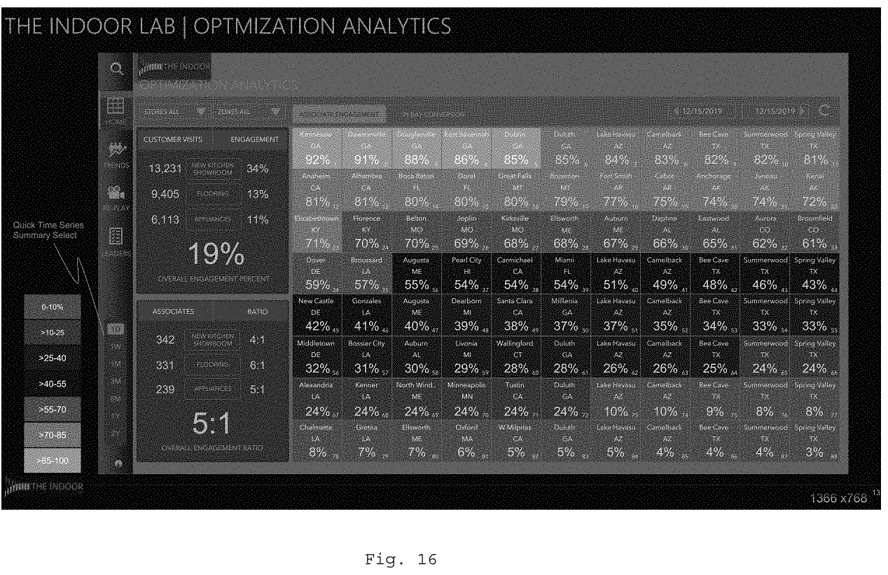

FIG. 16 shows optimization analytics comparing all stores.

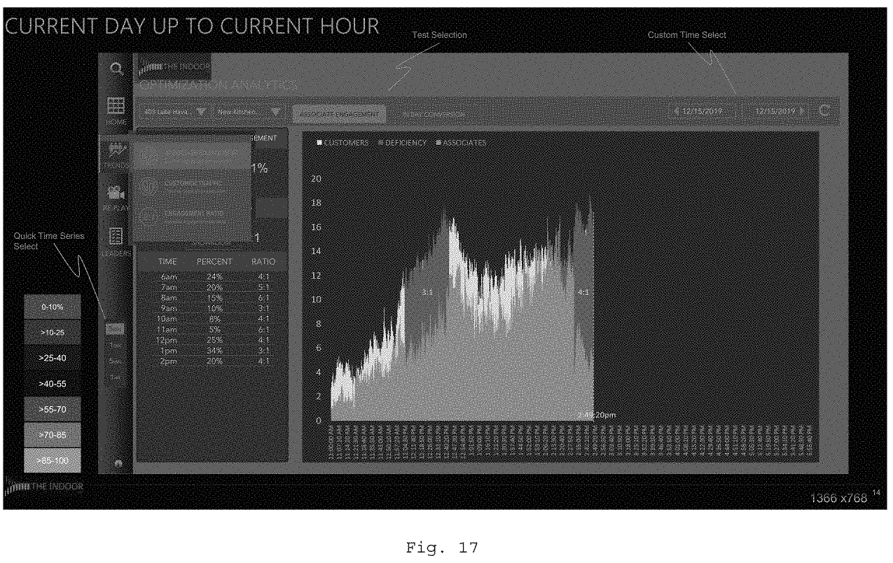

FIG. 17 shows optimization analytics which show a deficiency ratio of customers to employees, which can be used for optimizing the number of employees.

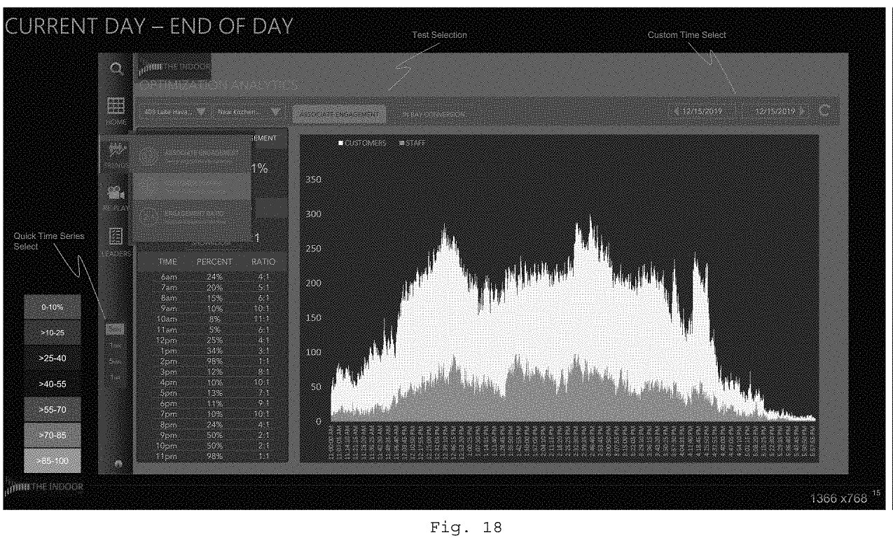

FIG. 18 shows another graph of associate engagement.

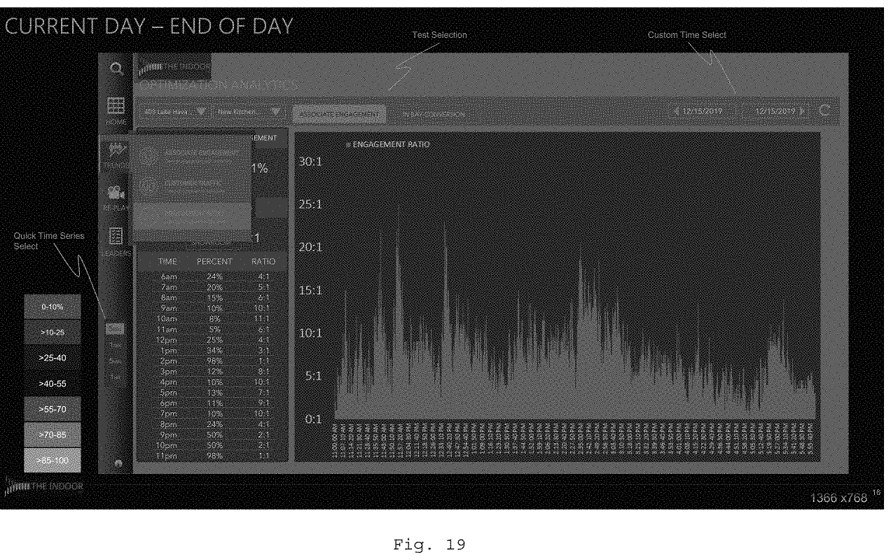

FIG. 19 shows another graph of engagement ratio.

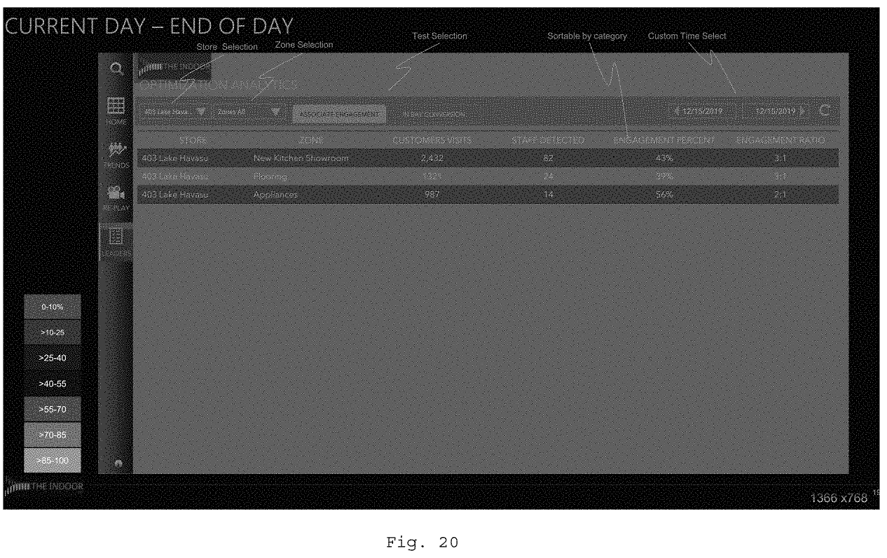

FIG. 20 shows aggregate data about the number of customers versus staff detected and the engagement ratio.

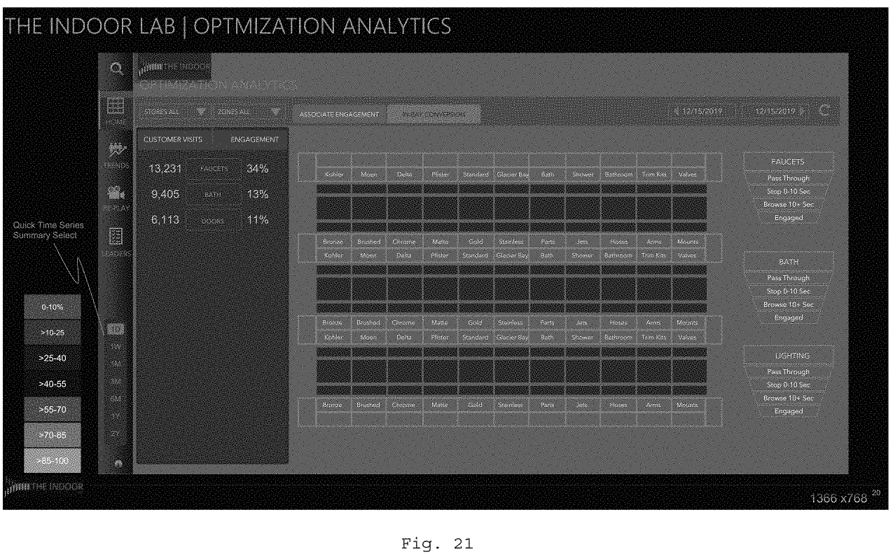

FIG. 21 shows in-bay conversion data for a box store.

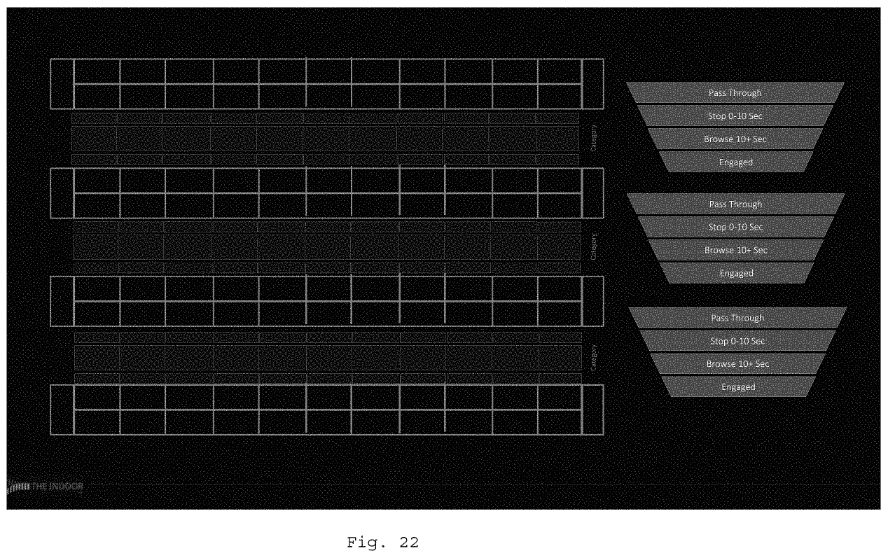

FIG. 22 shows the zone definitions for determining in-bay conversion.

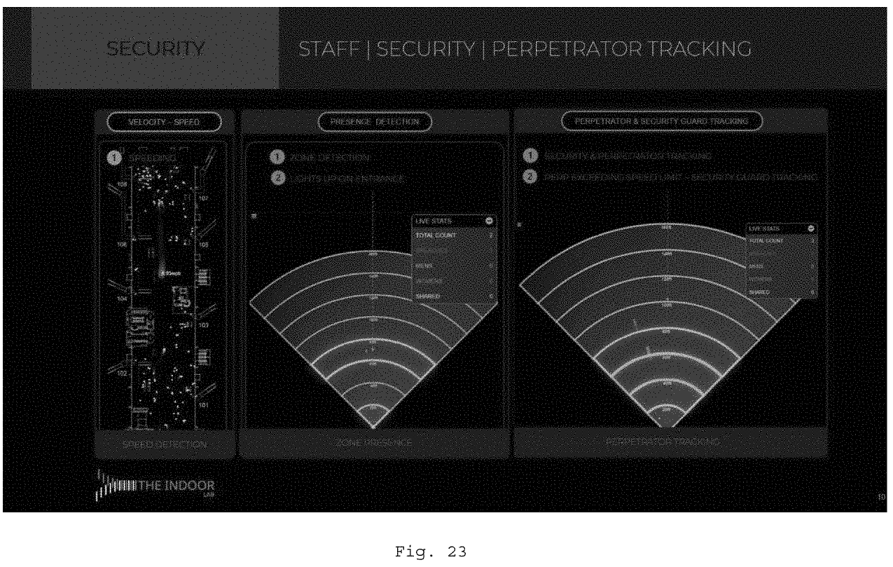

FIG. 23 shows a graph related to perpetrator tracking showing either zone detection or a perpetrator exceeding a speed limit and being tracked by a staff person.

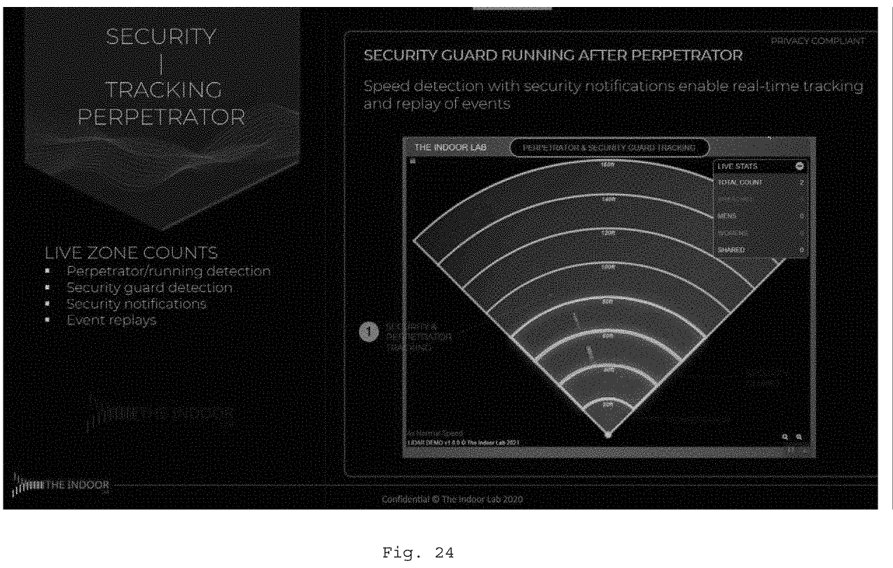

FIG. 24 shows another graph related to perpetrator tracking showing a security guard running after a perpetrator.

What is claimed is:

1. A system for tracking people moving through a predefined area, comprising:
an electronic tracking device for real-time tracking of people as they move through a predefined area.

2. The system of claim 1 wherein the electronic tracking device is one or more LIDAR devices.

3. The system of claim 2 wherein employees or staff operating in the predefined area wear a reflective badge to allow the system to differentiate between employees or staff and other people in the predefined area.

4. The system of claim 1 further including software for providing an indication of which parts of the predefined area need to be cleaned by tracking which parts of the predefined area were occupied by the people.

5. The system of claim 4 wherein the software tracks employees or staff to ensure the areas occupied by people were cleaned.

6. The system of claim 1 wherein the system is used for determining whether the predefined area enforces good social distancing rules.

7. The system of claim 1 further including software for providing cleaning alerts.

8. The system of claim 1 further including software for detecting social distancing adherence.

9. The system of claim 1 further including software for the ability to replay and re-analyze historical data.

10. The system of claim 1 further including software for the ability to measure density/saturation and frequency of traffic.

11. The system of claim 1 further including software for the ability to measure what has been cleaned, what has not been cleaned, and when.

12. The system of claim 1 further including software for the ability to score/rate cleanliness and adherence of social distancing of a place of business.

13. The system of claim 1 further including software for the ability to publish data for private/public consumption via an API (application program interface).

14. The system of claim 1 further including software for the providing a cleaning alert when an area exceeds a predetermined maximum recommended usage.

15. The system of claim 1 further including software for the tracking of paths, pathing and common paths.

16. The system of claim 1 further including software for the ability to track frequency of saturation of an area.

17. The system of claim 1 further including software for the ability to schedule cleaning based on historical pathing and saturation trends.

18. The system of claim 1 further including software for interfacing with automated cleaning devices to schedule cleaning of an area.

19. The system of claim 1 further including software for alerting the closest staff person to a detected perpetrator.

20. The system of claim 1 further including software for detecting a left behind bag.

21. The system of claim 2 wherein employees or staff operating in the predefined area wear a first type of reflective badge to allow the system to differentiate between employees or staff and other people in the predefined area and a second category of persons wear a second type of reflective badge to allow the system to differentiate between employees or staff, the second category of persons and everybody else.
